(19) United States
(12) Patent Application Publication
(10) Pub. No.: US 2013/0328418 A1
(43) Pub. Date: Dec. 12, 2013

(54) ELECTRIC MOTOR HAVING A SEGMENTED STATOR

(71) Applicants: Andreas Ewert, Lichtenau (DE); Jochen Weidlich, Rastatt (DE); Martin Gutmann, March (DE); Bjoern Nommensen, Bad Muender (DE)

(72) Inventors: Andreas Ewert, Lichtenau (DE); Jochen Weidlich, Rastatt (DE); Martin Gutmann, March (DE); Bjoern Nommensen, Bad Muender (DE)

(73) Assignee: ROBERT BOSCH GMBH, Stuttgart (DE)

(21) Appl. No.: 13/811,630

(22) PCT Filed: May 24, 2011
(86) PCT No.: PCT/EP11/58449

§ 371 Date: Jul. 1, 2013

(30) Foreign Application Priority Data
Jul. 21, 2010 (DE) 10 2010 031 584.2

(51) Int. Cl. H02K 1/18

(52) U.S. Cl. CPC H02K 1/185
USPC 310/43

(57) ABSTRACT

In the case of an electric motor having a rotor and a stator, which has at least one first and one second stator segment (210, 220) which are each provided at least in places with a plastic sheath (410, 520), the plastic sheaths (410, 520) of the first and second stator segments (210, 220) are connected to one another via at least one plastic connecting element (422, 424), which is welded at least to the plastic sheath (520) of the second stator segment (220).

### BACKGROUND OF THE INVENTION

The present invention relates to an electric motor having a rotor and a stator, which has at least a first and a second stator segment, which are each provided, at least sectionally, with a plastics sheath.

DE 198 57 954 A1 describes such an electric motor, whose stator has a plurality of stator segments surrounded by plastics sheaths produced by injection molding. These stator segments are arranged in the form of a ring and are fastened to one another at joining faces facing one another in the circumferential direction via tooth/slot connections.

One disadvantage with this prior art consists in that, given a high level of mechanical loading on such an electric motor, the tooth/slot connections between the individual stator segments can become partially or completely detached and therefore problem-free functioning of the electric motor can no longer be ensured.

### SUMMARY OF THE INVENTION

One object of the invention therefore consists in providing a novel electric motor having a segmented stator, in which a permanent connection between adjacent stator segments can be achieved.

This problem is achieved by an electric motor having a rotor and a stator, which has at least a first and a second stator segment, which are each provided, at least sectionally, with a plastics sheath. The plastics sheaths of the first and second stator segments are connected to one another via at least one plastics connecting element, which is welded at least to the plastics sheath of the second stator segment.

The invention therefore enables the provision of an electric motor having a segmented stator, in which adjacent stator segments are fastened to one another in a stable and reliable manner.

In accordance with one embodiment, the plastics connecting element is in the form of a lug.

Therefore, a simple and inexpensive connecting element can be provided.

The plastics sheath of the first stator segment and the plastics connecting element are preferably formed integrally.

Therefore, a secure and permanent connection between the connecting element and the plastics sheath of the first stator segment is made possible in a simple manner.

In accordance with one embodiment, the plastics connecting element is welded to the plastics sheath of the first stator segment.

The invention therefore enables the provision of an inexpensive, separate connecting element which is connected securely and reliably to the plastics sheaths of the first and second stator segments.

Preferably, the plastics connecting element is in the form of a ring.

Therefore, a simple and stable connecting element can be provided.

In accordance with one embodiment, the plastics connecting element is connected to the second and/or first stator segment by means of ultrasound welding.

Therefore, the connecting element can be welded to the first and/or second stator segment comparatively quickly and reliably.

Preferably, the plastics sheaths of the first and second stator segments and the plastics connecting element have a thermoplastic plastic.

Therefore, problem-free and secure welding of the connecting element to the plastics sheath(s) can be made possible.

In accordance with one embodiment, the plastics sheaths at least sectionally enclose at least in each case one yoke section and/or a tooth base section of the first and second stator segments.

The invention therefore enables stable and reliable fixing of the plastics sheaths to the stator segments.

The plastics connecting element is preferably arranged in the region of the yoke sections. The plastics connecting element can likewise be arranged in the region of the tooth base sections.

Therefore, the connection of the stator segments at easily accessible positions on the segmented stator can be made possible.

The problem mentioned at the outset is also solved by a stator segment for a stator of an electric motor, which stator segment is provided, at least sectionally, with a plastics sheath. A plastics connecting element is provided on the plastics sheath for welding to a plastics sheath of another stator segment.

The invention therefore enables a stable and reliable connection of the stator segment to another stator segment.

In accordance with one embodiment, at least one energy direction transmitter is formed on the plastics connecting element.

Thus, during a welding operation, a precise emission of energy in the region of the plastics connecting element can be achieved which enables defined and controlled production of melt in this region.

### BRIEF DESCRIPTION OF THE DRAWINGS

The invention will be explained in more detail in the description below using exemplary embodiments illustrated in the drawings, in which:

FIG. 1 shows a schematic view of an electric motor in accordance with one embodiment,

FIG. 2 shows a plan view of a segmented laminate stack in accordance with one embodiment, with which laminate stack the stator core shown in FIG. 1 can be realized,

FIG. 3 shows a perspective view of an individual core segment in accordance with one embodiment,

FIG. 4 shows a perspective view of the core segment provided with an individual winding shown in FIG. 3, which core segment has a plastics sheath, on which lug-shaped plastics connecting elements are formed,

FIG. 5 shows a plan view of a first arrangement with a multiplicity of stator segments, with which first arrangement the stator shown in FIG. 1 can be realized, and

FIG. 6 shows a plan view of a second arrangement having a multiplicity of stator segments, with which second arrangement the stator shown in FIG. 1 can be realized.

### DETAILED DESCRIPTION

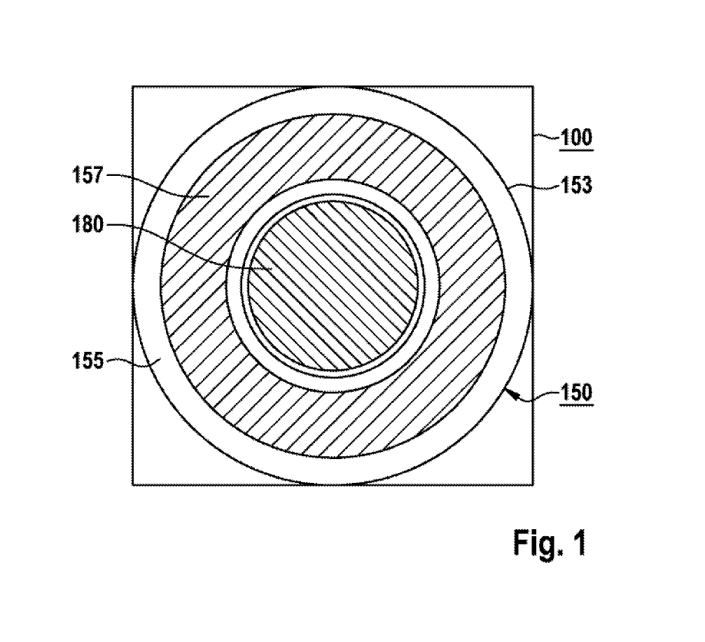

FIG. 1 shows an electric motor 100, which is, by way of example, in the form of an internal-rotor motor having a segmented external stator 150 and an internal rotor 180. The segmented external stator 150 has, illustratively, a segmented stator core 153 which is provided with a plastics sheath 155 and on which a stator winding 157 is arranged.

It is noted that the electric motor 100 in FIG. 1 is only illustrated schematically since the design and functionality of a suitable electric motor are sufficiently well known from the prior art, with the result that, for reasons of conciseness and simplicity of the description, no detailed description of the electric motor 100 has been provided here. Furthermore, it is noted that the electric motor 100 is illustrated as an internal-rotor motor merely by way of example and not by way of restriction of the invention. Rather, the invention can be used in all types of motors with segmented stators. Furthermore, it is noted that the depiction of an external stator has a merely exemplary character and the invention can likewise be used, for example, in the case of ring-shaped internal stators or primary parts of linear motors.

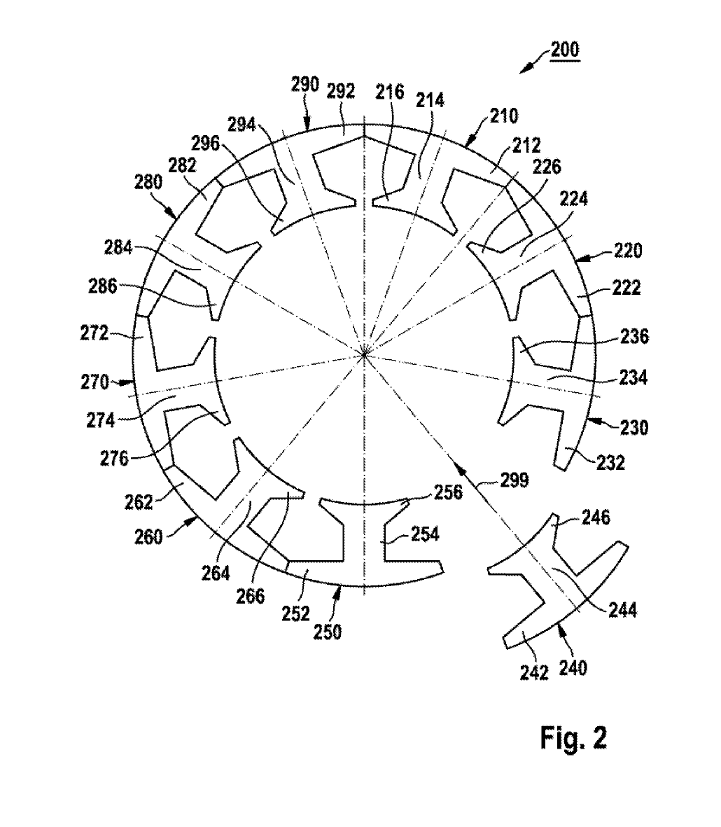

FIG. 2 shows an exemplary arrangement 200 having a multiplicity of substantially correspondingly designed core segments 210, 220, 230, 240, 250, 260, 270, 280, 290, which can be used for realizing the segmented stator core 153 shown in FIG. 1 in accordance with one embodiment. However, it is noted that the use illustrated of the nine core segments 210, 220, 230, 240, 250, 260, 270, 280, 290 has a merely exemplary character and should not be understood to be a restriction of the invention, which can be used in the case of any desired number of core segments. Furthermore, other stator core topologies can also be used than those shown in FIG. 2; for example linked core segments can be used instead of the separate core segments 210, 220, 230, 240, 250, 260, 270, 280, 290, etc.

The core segments 210, 220, 230, 240, 250, 260, 270, 280, 290 are formed illustratively in the form of a T from a soft-magnetic material and have, for example, a multiplicity of stacked sheet-metal laminations, which are preferably fastened to one another, for example welded to one another, and are formed by stamped electric steel sheets. Each core segment 210, 220, 230, 240, 250, 260, 270, 280, 290 has a yoke section 212, 222, 232, 242, 252, 262, 272, 282 or 292, which in each case tapers in a tooth section 214, 224, 234, 244, 254, 264, 274, 284 or 294, which for its part widens illustratively into a wider tooth base section 216, 226, 236, 246, 256, 266, 276, 286 or 296. The core segments 210, 220, 230, 240, 250, 260, 270, 280, 290 are formed in such a way that they can be joined together in the form of a ring, as indicated by an arrow 299, wherein the yoke sections 212, 222, 232, 242, 252, 262, 272, 282, 292 of core segments 210, 220, 230, 240, 250, 260, 270, 280 or 290, which are adjacent to one another in the circumferential direction, each bear against one another.

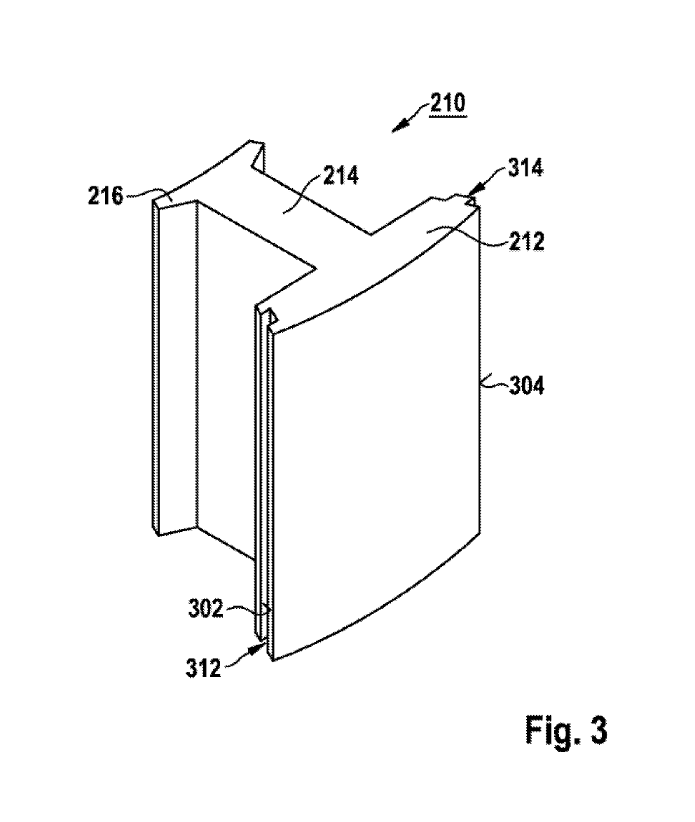

FIG. 3 shows the core segment 210 shown in FIG. 2 for illustrating an embodiment, in which a first lateral joining face 302 is provided with a connecting groove 312 formed in the axial direction on the yoke section 212, and a connecting web 314 is formed in the axial direction on a second lateral joining face 304. The connecting groove 312 and the connecting web 314 serve to make a connection with a connecting web or a connecting groove which are each provided on adjacent core segments.

In other words, the core segments 220, 230, 240, 250, 260, 270, 280, 290 shown in FIG. 2, as described above, have a design which substantially corresponds to the design of the core segment 210. Correspondingly, the design of the core segment 210 described in FIG. 3 can be understood as being representative of the core segments 220, 230, 240, 250, 260, 270, 280, 290, which therefore likewise each have a connecting groove and a connecting web on their yoke sections 222, 232, 242, 252, 262, 272, 282 or 292, which connecting groove and connecting web are connected to associated connecting webs and connecting grooves of adjacent core segments. In the arrangement 200 in FIG. 2, therefore, the connecting groove 312 of the core segment 210 can be connected to an associated connecting web of the core segment 220, and the connecting web 314 can be connected to an associated connecting groove of the core segment 290, etc.

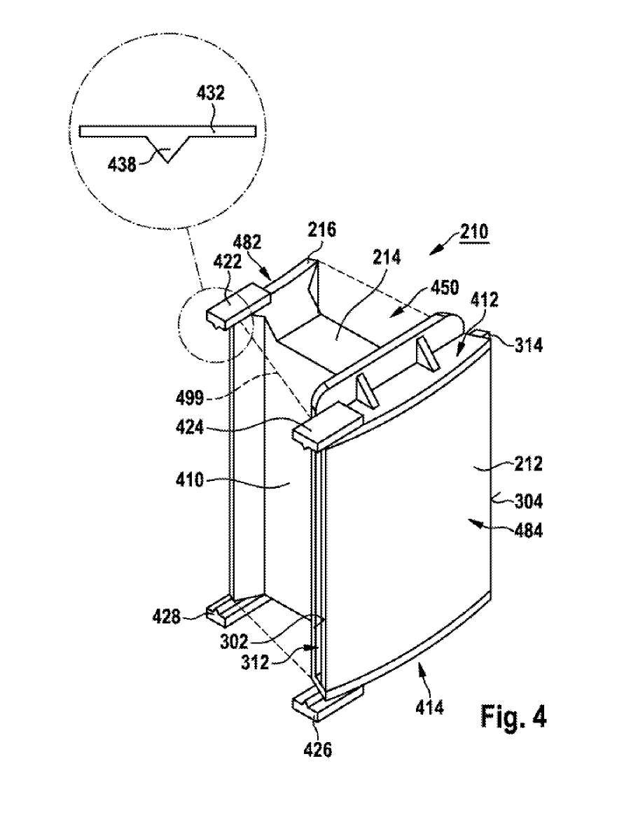

FIG. 4 shows the core segment 210 shown in FIG. 3, which is provided illustratively with a plastics sheath 410. In accordance with one embodiment, the plastics sheath 410 is formed by a plastics injection molding on the core segment 210 and encloses at least the yoke section 212 and the tooth base section 216 at least sectionally. As an alternative to this, the plastics sheath 410 can also be formed from one or more plastics parts which can be plugged onto the core segment 210. Furthermore, the plastics sheath 410 can be used for fixing the stacked sheet-metal laminations forming the core segment 210 to one another, with the result that separate fixing by means of welding, for example, can be dispensed with.

Preferably, the plastics sheath 410 encloses the core segment 210 completely or at least such that only side faces 482, 484 which are remote from one another and which are formed on the tooth base section 216 and on the yoke section 212, respectively, are not enclosed by the plastics sheath 410. In this case, the plastics sheath 410 illustratively forms a winding slot 450, which encloses at least the tooth section 214 and is designed to accommodate an individual winding 499, indicated by dashed lines, which is wound, for example by means of flyer winding or coil winding onto the plastics sheath 410, wherein the plastics sheath 410 preferably electrically insulates the individual winding 499 from the core segment 210. The core segment 210 provided with the plastics sheath 410 and the individual winding 499 is also referred to below as “stator segment”.

In accordance with one embodiment, plastics connecting elements 422, 424, 426, 428 in the form of a lug are fastened to the plastics sheath 410. These plastics connecting elements are also referred to below as “connecting lugs” and are provided illustratively at an (upper in FIG. 4) axial end 410 or a (lower in FIG. 4) axial end 414 of the plastics sheath 410. For example, the connecting lugs 422, 424, 426, 428 are integrally formed on the plastics sheath 410 or formed in one piece therewith or fastened thereto in any suitable manner, for example welded or adhesively bonded thereto. The plastics sheath 410 and the connecting lugs 422, 424, 426, 428 preferably have a thermoplastic plastic.

Said connecting lugs 424, 426 are provided illustratively at the axial ends 412 and 414, respectively, in the region of the first lateral joining face 302 formed at the yoke section 212. The connecting lugs 422, 428 are provided on the same side of the stator segment 210 at the axial ends 412 and 414, respectively, in the region of the tooth base section 216. However, it is noted that the number and position of the connecting lugs 422, 424, 426, 428 have a merely exemplary character and should not be understood as a restriction of the invention. Instead, any desired number of connecting lugs can be used which are provided for example exclusively in the region of the yoke section 212 or in the region of the tooth base section 216 and/or exclusively at the axial end 412 or at the axial end 414 of the plastics sheath 410.

In accordance with one embodiment, the connecting lugs 422, 424, 426, 428 have a substantially corresponding design, with a strip-shaped or lug-like section 432, on which optionally an energy direction transmitter 438 can be formed. Said energy direction transmitter can be elongate or punctiform and is formed at the connecting lugs 422 and 428 or 424 and 426 in each case on mutually facing sides.

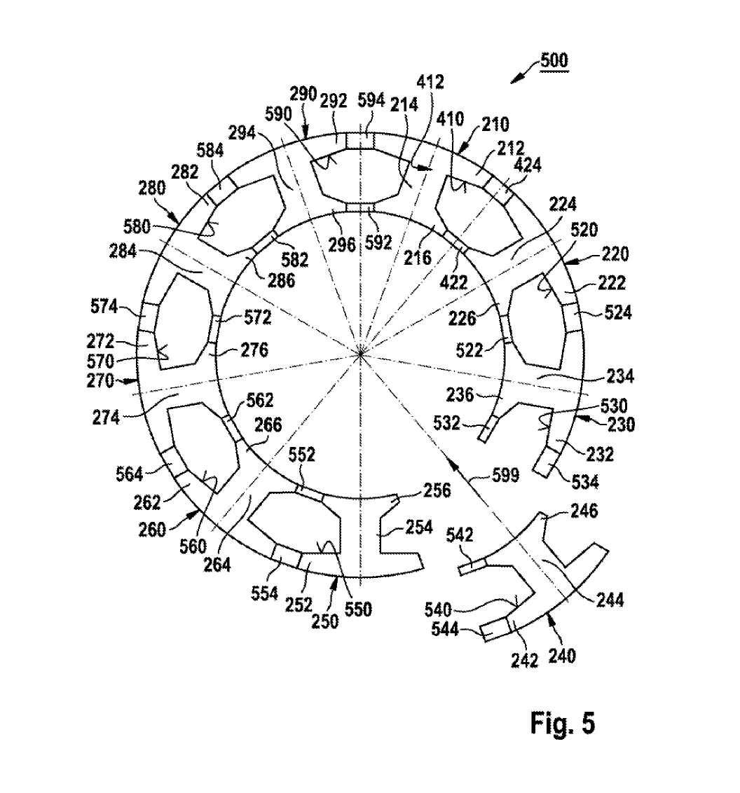

FIG. 5 shows an exemplary arrangement 500, with which the segmented external stator 150 shown in FIG. 1 can be realized. In the arrangement 500, the stator segment 210 shown in FIG. 4 and the core segments 220, 230, 240, 250, 260, 270, 280, 290 shown in FIG. 2 are arranged in the form of a ring.

In accordance with one embodiment, the core segments 220, 230, 240, 250, 260, 270, 280, 290 have a design which substantially corresponds to the design of the stator segment 210 shown in FIG. 4, i.e. they are each provided with a corresponding plastics sheath 520, 530, 540, 550, 560, 570, 580 or 590, which has a similar design to the plastics sheath 410 in FIG. 4. In each case connecting lugs 522, 524, 532, 534, 542, 544, 552, 554, 562, 564, 572, 574, 582, 584 or 592 and 594 are provided on said plastics sheaths and have a similar design to the connecting lug 422 shown in FIG. 4. Furthermore, an individual winding corresponding to the individual winding 499 in FIG. 4 is wound onto each of the plastics sheaths 520, 530, 540, 550, 560, 570, 580, 590, with the result that the core segments 220, 230, 240, 250, 260, 270, 280, 290 equipped in this way are also referred to below as “stator segments”. The individual windings, with the individual winding 499 shown in FIG. 4, realize the stator winding 157 shown in FIG. 1, for example. However, the illustration of said individual windings has been dispensed with in FIG. 5 for reasons of simplicity and clarity of the figure.

However, it is noted that, in FIG. 5, only the connecting lugs 522, 524, 532, 534, 542, 544, 552, 554, 562, 564, 572, 574, 582, 584 or 592 and 594 provided at the upper axial end of the stator segments 520, 530, 540, 550, 560, 570, 580, 590, which upper axial end corresponds to the upper axial end 412 of the stator segment 210, are visible. Preferably, likewise corresponding connecting lugs are formed at the opposite axial end, which corresponds to the lower axial end 414 of the stator segment 210 in FIG. 4.

FIG. 5 illustrates fitting of the arrangement 500, in which the stator segments 210, 220, 230, 240, 250, 260, 270, 280, 290 are arranged in the form of a ring, as indicated by an arrow 599. The stator segments 210, 220, 230, 240, 250, 260, 270, 280, 290 arranged in the form of a ring in such a way can be mechanically prefixed in order to simplify subsequent process steps, for example via suitable iron or plastics parts, via connecting grooves and webs formed in the plastics sheaths 410, 520, 530, 540, 550, 560, 570, 580, 590 (for example groove 312 and web 314 in FIG. 4), or by individual windings connected to form the stator winding 157 shown in FIG. 1.

Then, the connecting lugs 422, 424, 522, 524, 532, 534, 542, 544, 552, 554, 562, 564, 572, 574, 582, 584 or 592 and 594, which are provided on the plastic sheaths 410, 520, 530, 540, 550, 560, 570, 580, 590 of the stator segments 210, 220, 230, 240, 250, 260, 270, 280 or 290 are fastened to the plastics sheaths 520, 530, 540, 550, 560, 570, 580, 590 or 410 of in each case adjacent stator segments 220, 230, 240, 250, 260, 270, 280, 290 or 210. This fastening is preferably performed by means of welding, for example ultrasound welding, or an alternative plastics joining process, for example laser plastics welding. In this case, in accordance with one embodiment, the associated energy direction transmitters (438 in FIG. 4) are sealed off, with the result that the connecting lugs 422, 424, 522, 524, 532, 534, 542, 544, 552, 554, 562, 564, 572, 574, 582, 584, 592, 594 are connected or welded to one another by the energy direction transmitters (438 in FIG. 4) being sealed off whilst at the same time the respective adjacent plastics sheaths 520, 530, 540, 550, 560, 570, 580, 590 or 410 are fused to the corresponding plastics sheaths 520, 530, 540, 550, 560, 570, 580, 590 or 410 in the region of the connecting lugs 422, 424, 522, 524, 532, 534, 542, 544, 552, 554, 562, 564, 572, 574, 582, 584 or 592 and 594.

However, it is noted that the fastening of the connecting lugs 422, 424, 522, 524, 532, 534, 542, 544, 552, 554, 562, 564, 572, 574, 582, 584 or 592 and 594 on the plastics sheaths 520, 530, 540, 550, 560, 570, 580, 590 or 410 of in each case adjacent stator segments 220, 230, 240, 250, 260, 270, 280, 290 or 210 by means of welding is described merely for illustrative purposes of an exemplary embodiment and should not be regarded as a restriction of the invention. For example, an adhesive bonding method or any desired other connecting method can also be used for the fastening. Furthermore, the above-described use of the energy direction transmitters (438 in FIG. 4) also has merely an exemplary character and should not be considered to be a restriction of the invention, which can likewise be implemented without the use of such energy direction transmitters. For example, in each case one suitable, fusing additive material can be used for producing the melt during welding. However, the use of the energy direction transmitters is advantageous for achieving improved production of the melt during welding.

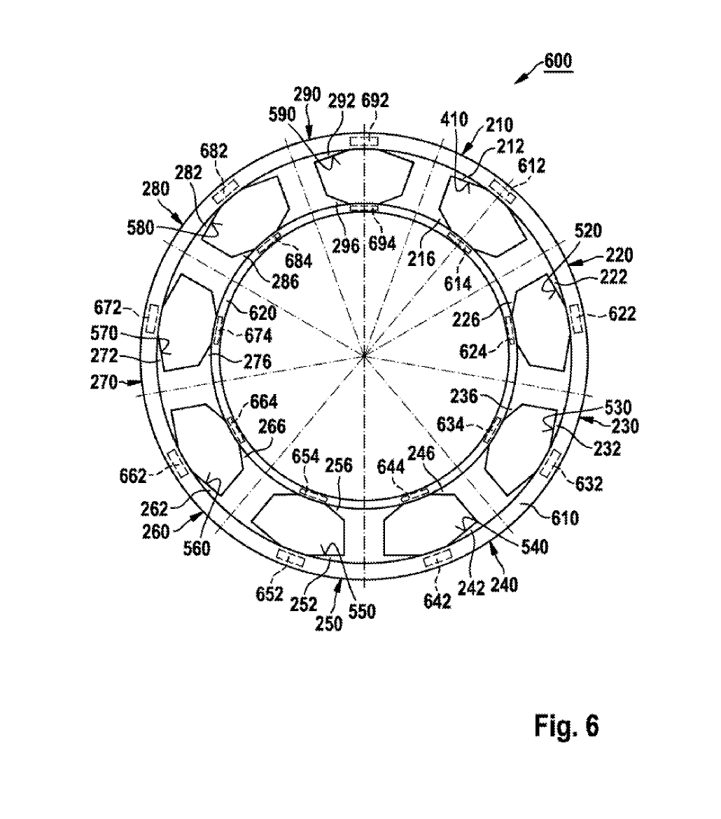

FIG. 6 shows an alternative arrangement 600, with which the segmented external stator 150 shown in FIG. 1 can likewise be realized. In the arrangement 600, in contrast to the arrangement 500 shown in FIG. 5, the plastics sheaths 410, 510, 520, 530, 540, 550, 560, 570, 580, 590 of the stator segments 210, 220, 230, 240, 250, 260, 270, 280 or 290 are formed without the connecting lugs 422, 424, 522, 524, 532, 534, 542, 544, 552, 554, 562, 564, 572, 574, 582, 584, 592, 594 in FIG. 5. Instead, one or more ring-shaped plastics connecting elements 610, 620, preferably formed from thermoplastic plastic, are used illustratively, with energy direction transmitters 612, 622, 632, 642, 652, 662, 672, 682, 692 or 614, 624, 634, 644, 654, 664, 674, 684, 694, indicated by way of example by dashed lines, being provided on the side faces of said connecting elements which face the stator segments 210, 220, 230, 240, 250, 260, 270, 280, 290. However, it is noted that the connecting elements 610, 620 are ring-shaped merely by way of example, and other configurations can also be used, for example star-shaped configurations.

In accordance with one embodiment, the stator segments 210, 220, 230, 240, 250, 260, 270, 280, 290 are arranged in the form of a ring for fastening to one another and the connecting rings 610, 620 are positioned over the yoke sections 212, 222, 232, 242, 252, 262, 272, 282, 292 or the tooth base sections 216, 226, 236, 246, 256, 266, 276, 286, 296 in such a way that the energy direction transmitters 612, 622, 632, 642, 652, 662, 672, 682, 692 or 614, 624, 634, 644, 654, 664, 674, 684, 694 are each arranged approximately in the region of contact faces between adjacent plastics sheaths 410, 510, 520, 530, 540, 550, 560, 570, 580, 590. Then, the connecting rings 610, 620 are welded while sealing off the energy direction transmitters 612, 622, 632, 642, 652, 662, 672, 682, 692 or 614, 624, 634, 644, 654, 664, 674, 684, 694 by means of ultrasound welding or an alternative plastics joining method to the plastics sheaths 410, 510, 520, 530, 540, 550, 560, 570, 580, 590.

However, it is noted that the fastening of the connecting rings 610, 620 to the plastics sheaths 410, 510, 520, 530, 540, 550, 560, 570, 580, 590 by means of welding is described merely for illustration of an exemplary embodiment and should not be regarded as a restriction of the invention. For example, an adhesive bonding method or any desired other connecting method can also be used for the fastening. Furthermore, it is noted that, in order to improve the strength between the stator segments 210, 220, 230, 240, 250, 260, 270, 280, 290, a further fixing operation can be performed, for example following the welding operations described in connection with FIGS. 5 and 6, for example an adhesive bonding, shrinking, shrinking and adhesive bonding or pressing operation. Said operations are conventional to a person skilled in the art, and therefore no detailed description of these operations has been given here for reasons of conciseness of the description.

1. An electric motor (100) having a rotor (180) and a stator (150), the stator having at least a first and a second stator segment (210, 220), the stator segments each being provided, at least sectionally, with a plastics sheath (410, 520), characterized in that the plastics sheaths (410, 520) of the first and second stator segments (210, 220) are connected to one another via at least one plastics connecting element (422, 424), which is welded at least to the plastics sheath (520) of the second stator segment (220).

2. The electric motor as claimed in claim 1, characterized in that the plastics connecting element (422, 424) is in the form of a lug.

3. The electric motor as claimed in claim 1, characterized in that the plastics sheath (410) of the first stator segment (210) and the plastics connecting element (422, 424) are formed integrally.

4. The electric motor as claimed in claim 1, characterized in that the plastics connecting element (422, 424) is welded to the plastics sheath (410) of the first stator segment (210).

5. The electric motor as claimed in claim 4, characterized in that the plastics connecting element (610, 620) is in the form of a ring.

6. The electric motor as claimed in claim 1, characterized in that the plastics connecting element (422, 424; 610, 620) is connected to the second and/or first stator segment (220, 210) by means of ultrasound welding.

7. The electric motor as claimed in claim 1, characterized in that the plastics sheaths (410, 520) of the first and second stator segments (210, 220) and the plastics connecting element (422, 424) have a thermoplastic plastic.

8. The electric motor as claimed in claim 1, characterized in that the plastics sheaths (410, 520) at least sectionally enclose at least in each case one yoke section (212, 222) and/or a tooth base section (216, 226) of the first and second stator segments (210, 220).

9. The electric motor as claimed in claim 8, characterized in that the plastics connecting element (422, 424) is arranged in the region of the yoke sections (212, 222).

10. The electric motor as claimed in claim 8, characterized in that the plastics connecting element (422, 424) is arranged in the region of the tooth base sections (216, 226).

11. A stator segment (210) for a stator (150) of an electric motor (100), which stator segment is provided, at least sectionally, with a plastics sheath (410), characterized in that a plastics connecting element (422, 424) is provided on the plastics sheath (410) for welding to a plastics sheath (520) of another stator segment (220).

12. The stator segment as claimed in claim 11, characterized in that at least one energy direction transmitter (432) is formed on the plastics connecting element (410).
